(19) United States
(12) Patent Application Publication
(10) Pub. No.: US 2025/0198558 A1
(43) Pub. Date: Jun. 19, 2025

(54) INTELLIGENT ROBOT FOR LONG-DISTANCE DETECTION IN DRAINAGE DEEP TUNNEL

(71) Applicant: China Construction Third Bureau Green Industry Investment Co., Ltd, Wuhan (CN)

(72) Inventors: Dingding TANG, Wuhan (CN); De ZHAN, Wuhan (CN); Rui JIANG, Wuhan (CN); Luyang XIE, Wuhan (CN); Xiaodong WANG, Wuhan (CN); Huang ZHAO, Wuhan (CN); Yan ZHOU, Wuhan (CN); Feiyue CHENG, Wuhan (CN); Lina ZHANG, Wuhan (CN); Yu ZHANG, Wuhan (CN); Yuan WANG, Wuhan (CN); Xuejin LIU, Wuhan (CN); Zhongxing LU, Wuhan (CN); Erwei GUO, Wuhan (CN)

(73) Assignee: China Construction Third Bureau Green Industry Investment Co., Ltd, Wuhan (CN)

(21) Appl. No.: 18/969,131

(22) Filed: Dec. 4, 2024

(30) Foreign Application Priority Data
Dec. 18, 2023 (CN) 202311745819.6

(51) Int. Cl. F16L 55/32; B08B 9/051; F16L 101/12; F16L 101/30

(52) U.S. Cl. CPC F16L 55/32; B08B 9/051; F16L 2101/12; F16L 2101/30

(57) ABSTRACT

An intelligent robot for long-distance detection in a drainage deep tunnel includes a tunnel pipe, a cleaning unit and a pushing unit. The cleaning unit includes a conduction assembly for conducting a blocked part of the tunnel pipe, a cleaning assembly located on one side of the conduction assembly and used for cleaning the conducted tunnel pipe, and a drive assembly arranged on one side of the cleaning assembly and used for synchronously driving the cleaning assembly and the conduction assembly to rotate; and the pushing unit is arranged on one side of the cleaning unit, and used for pushing the cleaning unit to move forwards along an interior of the tunnel pipe. When a traction rod moves from the middle to the corner of a ring slot, a regulating spring pushes an extending and retracting shaft to move outwards along second guide cylinders.

### CROSS-REFERENCE TO RELATED APPLICATIONS

The application claims priority to Chinese Patent Application No. 202311745819.6, filed on Dec. 18, 2023, the content of which is incorporated herein by reference in its entirety.

### TECHNICAL FIELD

The present disclosure relates to the technical field of tunnel drainage, and in particular to an intelligent robot for long-distance detection in a drainage deep tunnel.

### BACKGROUND

Tunnel drainage can not only ensure the smooth traffic, but also ensure the safety of a tunnel structure. Since water can reduce the strength of the tunnel structure, untimely drainage will bring serious losses to the tunnel, even leading to the collapse of the tunnel structure. Conversely, timely and adequate drainage made to the tunnel can improve a humid environment inside the tunnel, thus prolonging the service life of the tunnel. There are many factors affecting the rapid and timely water flow drainage of the tunnel, silt blockage to the tunnel is the most common factor affecting the drainage of the water flow in the tunnel, and therefore regular blockage detection inside the tunnel is required.

However, since the tunnel is usually long and mostly square, the existing way to detect the inside of the tunnel usually adopts a manual detection way for detection, which needs to consume a large number of detection time and labor, especially when the tunnel blocked by the silt leads to the incapability of draining the water flow in the tunnel. Due to the interference of water accumulated in the tunnel, the manual detection way adopted is more difficult to find the specific blockage position or discover the blockage position. It is difficult for workers to clear blockages rapidly due to the interference of the accumulated water and narrow working space in the tunnel, leading to serious traffic influence; and therefore it is necessary to research and develop an intelligent robot for long-distance detection in a deep drainage tunnel, to solve this issue.

The above-mentioned content is merely used for auxiliary understanding of the technical solution of the present disclosure, and does not mean to admit that the above-mentioned content is the closest existing technology.

### SUMMARY

The objective of the present disclosure is to provide an intelligent robot for long-distance detection in a drainage deep tunnel, to address the issue proposed in the above-mentioned background art that blockage detection for the existing long-distance tunnel by a manual detection way is time and labor consuming, and when the blockage in the tunnel causes the untimely drainage of the water flow, the manual way adopted is difficult to detect the blockage position and clear the blockage rapidly due to the interference of the water flow in the tunnel.

To achieve the above-mentioned objective, the present disclosure provides the technical solution below.

An intelligent robot for long-distance detection in a drainage deep tunnel includes a tunnel pipe, and further includes:
a cleaning unit, including a conduction assembly for conducting a blocked part of the tunnel pipe, a cleaning assembly located on one side of the conduction assembly and used for cleaning the conducted tunnel pipe, and a drive assembly arranged on one side of the cleaning assembly and used for synchronously driving the cleaning assembly and the conduction assembly to rotate; and
a pushing unit, which is arranged on one side of the cleaning unit, and used for pushing the cleaning unit to move forwards along an interior of the tunnel pipe.

Further, the drive assembly includes:
a drive motor, which is connected to an upper end of the pushing unit, wherein a drive end thereof is connected with a drive shaft;
a first gear, which is fixedly sleeved outside the drive shaft;
a bracket, which is sleeved outside the drive shaft and located between the first gear and the drive motor, wherein a bottom of the bracket is connected to the upper end of the pushing unit, to support the drive shaft;
a fixed block, which is fixedly connected to one side of the bracket, wherein an interior thereof is rotationally connected with a driven shaft; and
a driven gear, which is fixedly sleeved outside the driven shaft and meshed with the first gear, to drive the cleaning assembly and the conduction assembly to rotate.

Further, the cleaning assembly includes:
a mounting frame, which is fixedly connected to one end of the fixed block, wherein the driven shaft runs through the other side from one side of the mounting frame;
a turntable, which is fixedly sleeved outside the driven shaft and located inside the mounting frame;
second guide cylinders, wherein a plurality of groups of second guide cylinders are equidistantly connected along the outside of the turntable;
an extending and retracting shaft, which is slidingly plugged inside the second guide cylinders;
a regulating spring, which is plugged inside the second guide cylinders and used for regulating the position of an extending and retracting rod; and
a scraping plate, which is connected to a top of the extending and retracting rod, wherein the scraping plate is L-shaped and used for scraping off residual dirt on an inner wall of the conducted tunnel pipe.

Further, an inner wall of the mounting frame is provided with a ring slot, and one side of the extending and retracting shaft that is located on the ring slot is fixedly connected with a traction rod; and
the traction rod is L-shaped and has a top abutting against an inner wall of the ring slot, to perform an extending and retracting regulation on the extending and retracting shaft in cooperation with the regulating spring.

Further, the conduction assembly includes:
a dredging rotary block, which is connected to one side of the driven shaft, to locally dredge the blocked part in the tunnel pipe; and
a top column, which is fixedly connected to one end of the dredging rotary block that is relative to the driven shaft, to pierce silts at the blocked part and guide a dredging process of the dredging rotary block.

Further, one side of the dredging rotary block that is located on the top column is provided with a cutting and blocking edge, and the cutting and blocking edge is slant and used for reducing a resistance that the dredging rotary block is inserted into the blockage silts.

Further, the pushing unit includes:
a base plate, which is disposed inside the tunnel pipe and used for supporting the cleaning unit;
a drive wheel, which is connected to a lower end of the base plate, wherein a bottom thereof is disposed on a bottom wall of the tunnel pipe, to drive the base plate to move along the interior of the tunnel pipe; and
a pretensioning mechanism, which is arranged at an upper end of the base plate, wherein an upper end of the pretensioning mechanism abuts against the top of the tunnel pipe, to increase a grip between the drive wheel and the tunnel pipe.

Further, the pretensioning mechanism includes:
a first guide cylinder, which is fixedly connected to the upper end of the base plate;
a lifting shaft, which is slidingly plugged inside the first guide cylinder;
a mounting block, which is fixedly connected to an upper end of the lifting shaft, wherein an upper end thereof is connected to a guide wheel abutting against the inner wall of the tunnel pipe; and
a tightening spring, which is sleeved outside the lifting shaft and located between the mounting block and the first guide cylinder, to tighten the guide wheel upwards.

Compared with the existing technology, the present disclosure has the following beneficial effects.

Firstly, in the present disclosure, the robot is placed in the tunnel pipe such that the drive wheel is at the bottom of the tunnel pipe and the guide wheel abuts against the top wall of the tunnel pipe under the elastic force action of the tightening spring to the mounting block, the motor in the drive wheel is started such that the drive wheel drives the cleaning unit to move forwards along the tunnel pipe through the base plate, the grasp force of the drive wheel to the inner wall of the tunnel pipe is increased through the tightening action of the guide wheel and the drive wheel to the inner wall of the tunnel pipe, thus effectively avoiding a situation that the robot is blocked in the tunnel pipe and cannot move on due to the blocking effect of the blockage when the blockage is subsequently cleaned through the conduction assembly and the cleaning assembly.

Secondly, in the present disclosure, the drive motor is started to drive the first gear to rotate through the drive shaft, the first gear drives the driven shaft to rotate through the driven gear, the driven shaft drives the dredging rotary block to rotate, and in this process, the cutting and blocking edge is gradually inserted into the blockage under the pushing action of the drive wheel, the blockage that the cutting and blocking edge is inserted is scraped off through the rotating dredging rotary block, such that middle of the blockage is drilled by the dredging rotary block, thus achieving the effect of timely and automatically cleaning the blockage without artificial participation.

Thirdly, in the present disclosure, when the driven shaft drives the dredging rotary block to rotate, the driven shaft also drives the second guide cylinders to rotate through the turntable, the second guide cylinders drive the scraping plate to scrape off the residual blockage along the inner wall of the tunnel pipe through the extending and retracting shaft, thus achieving the effect of further cleaning the tunnel pipe initially conducted by the conduction assembly, and avoiding the blockage remained on the inner wall of the tunnel pipe after conduction blocking the drainage process.

Lastly, in the present disclosure, in a process that the extending and retracting shaft drives the scraping plate to scrape off the residual blockage on the edge of the tunnel pipe, the extending and retracting shaft also drives the traction rod to move along the trajectory of the ring slot. When the traction rod moves from the middle to the corner of the ring slot, the regulating spring pushes the extending and retracting shaft to move outwards along the second guide cylinders, such that the scraping plate can scrape off the residual blockage at the corner of the tunnel pipe maximally. When the traction rod moves from the corner to the middle of the ring slot, the traction rod drives the extending and retracting shaft to shrink gradually along the second guide cylinders under the pushing force action of the ring slot to the traction rod, such that the scraping plate can scrape off the residual blockage in a manner of fitting with the side wall of the tunnel pipe, and the scraped blockage is taken out by the water flow along the tunnel pipe, thus achieving the effect of completely cleaning the residual blockage of the tunnel pipe in an opposite direction.

### BRIEF DESCRIPTION OF THE DRAWINGS

FIG. 1 is a schematic diagram of an overall structure according to the present disclosure.

FIG. 2 is a cooperative relationship diagram of a conduction assembly and a cleaning assembly according to the present disclosure.

FIG. 3 is a schematic structural diagram of a pretensioning mechanism according to the present disclosure.

FIG. 4 is a schematic structural diagram of a conduction assembly according to the present disclosure.

FIG. 5 is a schematic diagram of an inner structure of a cleaning assembly according to the present disclosure.

FIG. 6 is a cooperative relationship diagram of a traction rod and a guide slot according to the present disclosure.

### DETAILED DESCRIPTION OF THE EMBODIMENTS

The technical solution in the embodiments of the present disclosure is clearly and completely elaborated below in combination with the drawings in the embodiments of the present disclosure. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

### Embodiment I

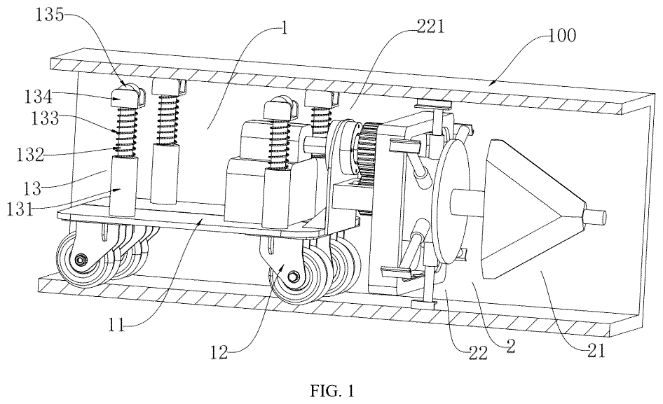

Please refer to FIGS. 1 to-6, a technical solution is provided in the present disclosure.

An intelligent robot for long-distance detection in a drainage deep tunnel includes a tunnel pipe 100, and further includes:
a cleaning unit 2, including a conduction assembly 21 for conducting a blocked part of the tunnel pipe 100, a cleaning assembly 22 located on one side of the conduction assembly 21 and used for cleaning the conducted tunnel pipe 100, and a drive assembly 221 arranged on one side of the cleaning assembly 22 and used for synchronously driving the cleaning assembly 22 and the conduction assembly 21 to rotate; and
a pushing unit 1, which is arranged on one side of the cleaning unit 2, and used for pushing the cleaning unit 2 to move forwards along an interior of the tunnel pipe 100.

It is to be noted that, during use, the pushing unit 1 is started to push the cleaning unit 2 to move forwards along the interior of the tunnel pipe 100, when the blockage in the tunnel pipe 100 blocks the tunnel pipe 100, leading to the incapability of draining the water flow in the tunnel pipe 100, the drive assembly 221 is started to drive the conduction assembly 21 and the cleaning assembly 22 to rotate synchronously, the conduction assembly 21 is gradually inserted into the blockage in a rotary manner when brought to be in contact with the blockage through the pushing unit 1, and the middle area of the blockage is conducted preferentially. After the conduction assembly 21 runs through the blockage, for the blockage adhered to the tunnel pipe 100 at the blockage edge, the cleaning assembly 22 scrapes off the residual blockage on the inner wall of the tunnel pipe 100 continuously in a rotary manner along the inner wall of the tunnel pipe 100, and the scraped blockage is drained out along the water flow, thus achieving the effect of rapidly cleaning the blockage in the tunnel without artificial participation.

As an improvement, as shown in FIG. 1, the drive assembly 221 includes:
a drive motor 2211, which is connected to an upper end of the pushing unit 1, wherein a drive end thereof is connected with a drive shaft 2212;
a first gear 2213, which is fixedly sleeved outside the drive shaft 2212;
a bracket 2214, which is sleeved outside the drive shaft 2212 and located between the first gear 2213 and the drive motor 2211, wherein a bottom of the bracket 2214 is connected to the upper end of the pushing unit 1, to support the drive shaft 2212;
a fixed block 2215, which is fixedly connected to one side of the bracket 2214, wherein an interior thereof is rotationally connected with a driven shaft 2217; and
a driven gear 2216, which is fixedly sleeved outside the driven shaft 2217 and meshed with the first gear 2213, to drive the cleaning assembly 22 and the conduction assembly 21 to rotate.

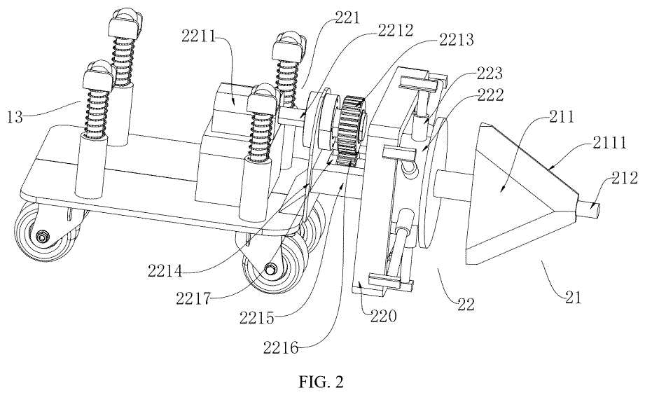

Further, as shown in FIG. 2, the cleaning assembly 22 includes:
a mounting frame 220, which is fixedly connected to one end of the fixed block 2215, wherein the driven shaft 2217 runs through the other side from one side of the mounting frame 220, and the mounting frame 220 being square;
a turntable 222, which is fixedly sleeved outside the driven shaft 2217 and located inside the mounting frame 220;
second guide cylinders 223, wherein a plurality of groups of second guide cylinders 223 are equidistantly connected along the outside of the turntable 222;
an extending and retracting shaft 225, which is slidingly plugged inside the second guide cylinders 223;
a regulating spring 224, which is plugged inside the second guide cylinders 223 and used for regulating the position of an extending and retracting rod; and
a scraping plate 226, which is connected to a top of the extending and retracting rod, wherein the scraping plate 226 is L-shaped and used for scraping off residual dirt on an inner wall of the conducted tunnel pipe 100.

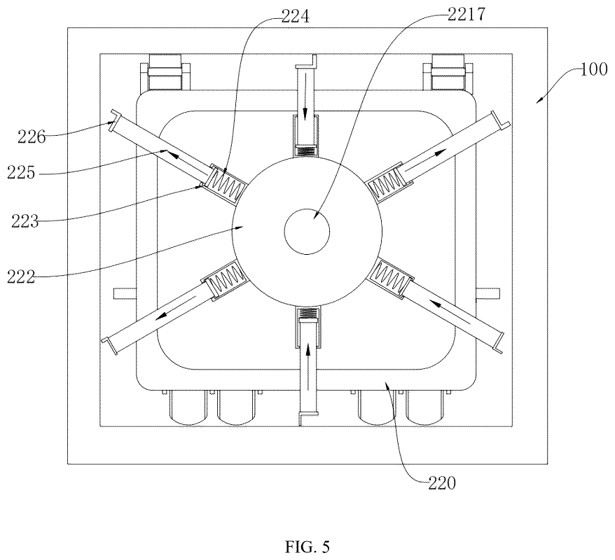

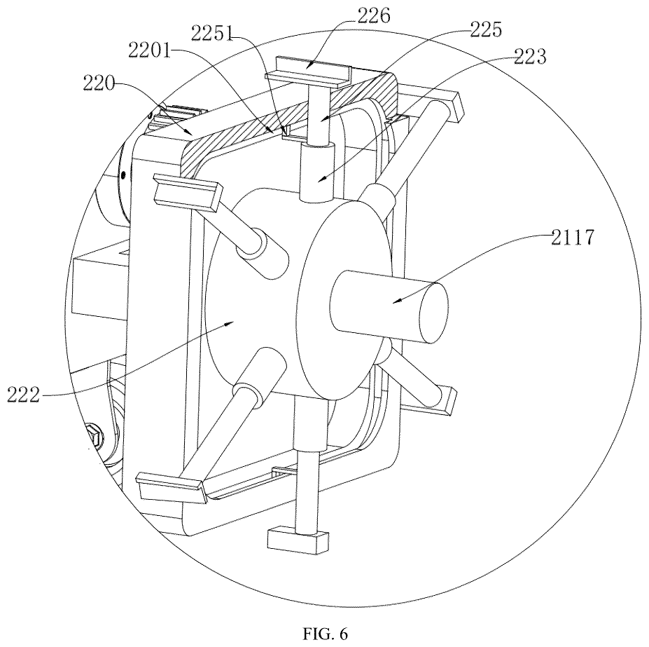

Further, as shown in FIGS. 5-6, an inner wall of the mounting frame 220 is provided with a ring slot 2201, and one side of the extending and retracting shaft 225 that is located on the ring slot 2201 is fixedly connected with a traction rod 2251; and
the traction rod 2251 is L-shaped and has a top abutting against an inner wall of the ring slot 2201, to perform an extending and retracting regulation on the extending and retracting shaft 225 in cooperation with the regulating spring 224.

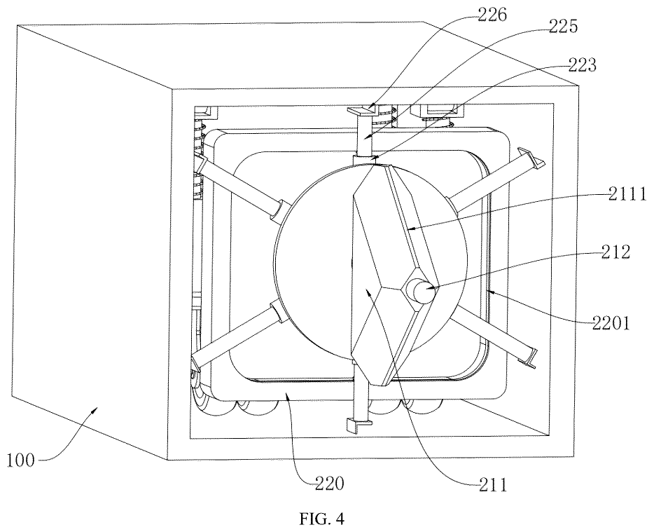

As shown in FIGS. 1 and 4, the conduction assembly 21 includes:
a dredging rotary block 211, which is connected to one side of the driven shaft 2217, to locally dredge the blocked part in the tunnel pipe 100; and
a top column 212, which is fixedly connected to one end of the dredging rotary block 211 that is relative to the driven shaft 2217, to pierce silts at the blocked part and guide a dredging process of the dredging rotary block 211.

In addition, as shown in FIG. 4, one side of the dredging rotary block 211 that is located on the top column 212 is provided with a cutting and blocking edge 2111, and the cutting and blocking edge 2111 is slant and used for reducing a resistance that the dredging rotary block 211 is inserted into the blockage silts.

As an improvement, as shown in FIGS. 1-3, the pushing unit 1 includes:
a base plate 11, which is disposed inside the tunnel pipe 100 and used for supporting the cleaning unit 2;
a drive wheel 12, which is connected to a lower end of the base plate 11, wherein a bottom thereof is disposed on a bottom wall of the tunnel pipe 100, to drive the base plate 11 to move along the interior of the tunnel pipe 100; and
a pretensioning mechanism 13, which is arranged at an upper end of the base plate 11, wherein an upper end of the pretensioning mechanism 13 abuts against the top of the tunnel pipe 100, to increase a grip between the drive wheel 12 and the tunnel pipe 100.

It should be supplemented that a motor for driving the drive wheel 12 to rotate is disposed in the drive wheel 12 and not drawn in the figure.

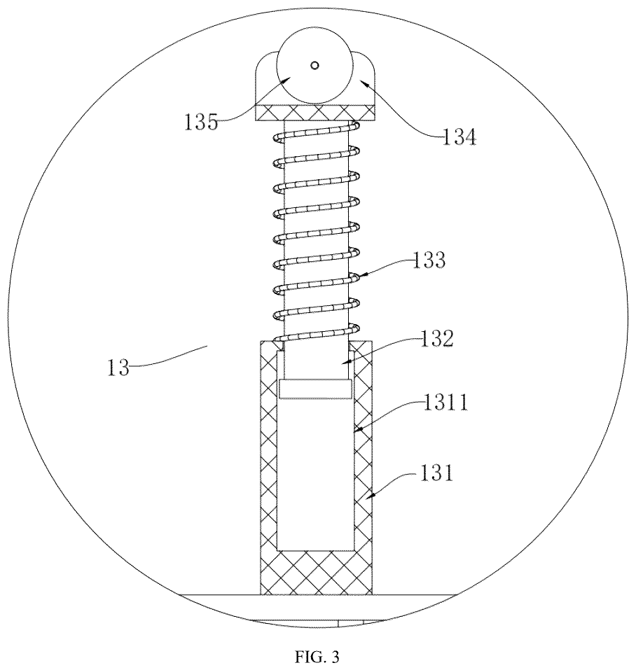

Further, as shown in FIG. 3, the pretensioning mechanism 13 includes:
a first guide cylinder 131, which is fixedly connected to the upper end of the base plate 11;
a lifting shaft 132, which is slidingly plugged inside the first guide cylinder 131, where a guide slot 1311 for guiding the lifting shaft 132 is disposed in the first guide cylinder 131;
a mounting block 134, which is fixedly connected to an upper end of the lifting shaft 132, wherein an upper end thereof is connected to a guide wheel 135 abutting against the inner wall of the tunnel pipe 100; and
a tightening spring 133, which is sleeved outside the lifting shaft 132 and located between the mounting block 134 and the first guide cylinder 131, to tighten the guide wheel 135 upwards.

It is to be noted that, as shown in FIG. 1, during initialization of the specific implementation process of the present disclosure, the robot is placed in the tunnel pipe 100 such that the drive wheel 12 is at the bottom of the tunnel pipe 100 and the guide wheel 135 abuts against the top wall of the tunnel pipe 100 under the elastic force action of the tightening spring 133 to the mounting block 134, the motor in the drive wheel 12 is started such that the drive wheel 12 drives the cleaning unit 2 to move forwards along the tunnel pipe 100 through the base plate 11, the grasp force of the drive wheel 12 to the inner wall of the tunnel pipe 100 is increased through the tightening action of the guide wheel 135 and the drive wheel 12 to the inner wall of the tunnel pipe 100, thus effectively avoiding a situation that the robot is blocked in the tunnel pipe 100 and cannot move on due to the blocking effect of the blockage when the blockage is subsequently cleaned through the conduction assembly 21 and the cleaning assembly 22.

As shown in FIGS. 1, 2 and 4, as the robot continues to move along the interior of the tunnel pipe 100, when the robot meets a situation that the blockage inside the tunnel pipe 100 leads to the incapability of draining the water flow in the tunnel pipe 100, the top column 212 is inserted into the blockage first, then the drive motor 2211 is started to drive the first gear 2213 to rotate through the drive shaft 2212, the first gear 2213 drives the driven shaft 2217 to rotate through the driven gear 2216, the driven shaft 2217 drives the dredging rotary block 211 to rotate, and in this process, the cutting and blocking edge 2111 is gradually inserted into the blockage under the pushing action of the drive wheel 12, the blockage that the cutting and blocking edge 2111 is inserted is scraped off through the rotating dredging rotary block 211, such that middle of the blockage is drilled by the dredging rotary block 211, thus achieving the effect of timely and automatically cleaning the blockage without artificial participation;

As shown in FIGS. 4-6, after the conduction assembly 21 runs through the blockage, for the residual blockage that is adhered to the inner wall of the tunnel pipe 100 after the blockage is dredged through the dredging rotary block 211, when the driven shaft 2217 drives the dredging rotary block 211 to rotate, the driven shaft 2217 also drives the second guide cylinders 223 to rotate through the turntable 222, the second guide cylinders 223 drive the scraping plate 226 to scrape off the residual blockage along the inner wall of the tunnel pipe 100 through the extending and retracting shaft 225, thus achieving the effect of further cleaning the tunnel pipe 100 initially conducted by the conduction assembly 21, and avoiding the blockage remained on the inner wall of the tunnel pipe 100 after conduction blocking the drainage process.

As shown in FIGS. 5-6, to clean the inner wall of the square tunnel pipe 100, in a process that the extending and retracting shaft 225 drives the scraping plate 226 to scrape off the residual blockage on the edge of the tunnel pipe 100 in the present disclosure, the extending and retracting shaft 225 also drives the traction rod 2251 to move along the trajectory of the ring slot 2201. When the traction rod 2251 moves from the middle of the ring slot 2201 to the corner, the regulating spring 224 pushes the extending and retracting shaft 225 to move outwards along the second guide cylinders 223, such that the scraping plate 226 can scrape off the residual blockage at the corner of the tunnel pipe 100 maximally. When the traction rod 2251 moves from the corner of the ring slot 2201 to the middle, the traction rod 2251 drives the extending and retracting shaft 225 to shrink gradually along the second guide cylinders 223 under the pushing force action of the ring slot 2201 to the traction rod 2251, such that the scraping plate 226 can scrape off the residual blockage in a manner of fitting with the side wall of the tunnel pipe 100, and the scraped blockage is taken out by the water flow along the tunnel pipe 100, thus achieving the effect of completely cleaning the residual blockage of the tunnel pipe 100 in an opposite direction.

It is noted that, in this text, relational terms “first”, “second” and the like are merely used for separating one entity or operation from another entity or operation, rather than not necessarily requiring or implying any actual relation or sequence between the entity and the operation. In addition, terms “include” and “contain” or any other variant are intended to cover nonexclusive inclusions herein, so that a process, method, goods or device including a series of elements not only includes those elements but also includes other elements which are not clearly listed or further includes elements intrinsic to the process, the method, the goods or the device.

Although the embodiments of the present disclosure have been presented and described, those of ordinary skill in the art may understand that various changes, modifications, replacements and deformations can be made to these embodiments without deviating from the principle of spirit of the present disclosure, and the scope of the present disclosure is defined by the appended claims and their equivalents.

What is claimed is:

1. An intelligent robot for long-distance detection in a drainage deep tunnel, comprising:
a tunnel pipe;
a cleaning unit, comprising a conduction assembly for conducting a blocked part of the tunnel pipe, a cleaning assembly located on one side of the conduction assembly and used for cleaning the conducted tunnel pipe, and a drive assembly arranged on one side of the cleaning assembly and used for synchronously driving the cleaning assembly and the conduction assembly to rotate; and
a pushing unit, arranged on one side of the cleaning unit and used for pushing the cleaning unit to move forwards along an interior of the tunnel pipe.

2. The intelligent robot for long-distance detection in the drainage deep tunnel according to claim 1, wherein the drive assembly comprises:
a drive motor, which is connected to an upper end of the pushing unit, wherein a drive end thereof is connected with a drive shaft;
a first gear, which is fixedly sleeved outside the drive shaft;
a bracket, which is sleeved outside the drive shaft and located between the first gear and the drive motor, wherein a bottom of the bracket is connected to the upper end of the pushing unit, to support the drive shaft;
a fixed block, which is fixedly connected to one side of the bracket, wherein an interior thereof is rotationally connected with a driven shaft; and
a driven gear, which is fixedly sleeved outside the driven shaft and meshed with the first gear, to drive the cleaning assembly and the conduction assembly to rotate.

3. The intelligent robot for long-distance detection in the drainage deep tunnel according to claim 2, wherein the cleaning assembly comprises:
a mounting frame, which is fixedly connected to one end of the fixed block, wherein the driven shaft runs through the other side from one side of the mounting frame;
a turntable, which is fixedly sleeved outside the driven shaft and located inside the mounting frame;
second guide cylinders, wherein a plurality of groups of second guide cylinders are equidistantly connected along the outside of the turntable;
an extending and retracting shaft, which is slidingly plugged inside the second guide cylinders;
a regulating spring, which is plugged inside the second guide cylinders and used for regulating the position of an extending and retracting rod; and
a scraping plate, which is connected to a top of the extending and retracting rod, wherein the scraping plate is L-shaped and used for scraping off residual dirt on an inner wall of the conducted tunnel pipe.

4. The intelligent robot for long-distance detection in the drainage deep tunnel according to claim 3, wherein
an inner wall of the mounting frame is provided with a ring slot, and one side of the extending and retracting shaft that is located on the ring slot is fixedly connected with a traction rod; and
the traction rod is L-shaped and has a top abutting against an inner wall of the ring slot, to perform an extending and retracting regulation on the extending and retracting shaft in cooperation with the regulating spring.

5. The intelligent robot for long-distance detection in the drainage deep tunnel according to claim 4, wherein the conduction assembly comprises:
a dredging rotary block, which is connected to one side of the driven shaft, to locally dredge the blocked part in the tunnel pipe; and
a top column, which is fixedly connected to one end of the dredging rotary block that is relative to the driven shaft, to pierce silts at the blocked part and guide a dredging process of the dredging rotary block.

6. The intelligent robot for long-distance detection in the drainage deep tunnel according to claim 5, wherein one side of the dredging rotary block that is located on the top column is provided with a cutting and blocking edge, and the cutting and blocking edge is slant and used for reducing a resistance that the dredging rotary block is inserted into the blockage silts.

7. The intelligent robot for long-distance detection in the drainage deep tunnel according to claim 1, wherein the pushing unit comprises:
a base plate, which is disposed inside the tunnel pipe and used for supporting the cleaning unit;
a drive wheel, which is connected to a lower end of the base plate, wherein a bottom thereof is disposed on a bottom wall of the tunnel pipe, to drive the base plate to move along the interior of the tunnel pipe; and
a pretensioning mechanism, which is arranged at an upper end of the base plate, wherein an upper end of the pretensioning mechanism abuts against the top of the tunnel pipe, to increase a grip between the drive wheel and the tunnel pipe.

8. The intelligent robot for long-distance detection in the drainage deep tunnel according to claim 7, wherein the pretensioning mechanism comprises;
a first guide cylinder, which is fixedly connected to the upper end of the base plate;
a lifting shaft, which is slidingly plugged inside the first guide cylinder;
a mounting block, which is fixedly connected to an upper end of the lifting shaft, wherein an upper end thereof is rotationally connected to a guide wheel abutting against the inner wall of the tunnel pipe; and
a tightening spring, which is sleeved outside the lifting shaft and located between the mounting block and the first guide cylinder, to tighten the guide wheel upwards.
